(19) United States
(12) Patent Application Publication
(10) Pub. No.: US 2019/0026825 A1
(43) Pub. Date: Jan. 24, 2019

(54) MBS POOLED PER RISK OF PRINCIPAL PERSERVANCE

(71) Applicant: Wenching Grace Lu, Missouri City, TX (US)

(72) Inventor: Wenching Grace Lu, Missouri City, TX (US)

(21) Appl. No.: 15/656,911

(22) Filed: Jul. 21, 2017

(51) Int. Cl. G06Q 40/02; G06Q 50/16

(52) U.S. Cl. CPC G06Q 40/025; G06Q 50/16

(57) ABSTRACT

The pooling of mortgage backed securities (MBS) will have tranches per risk of principal perseverance based on historical statistic figures. Tables providing auditable data regarding downside risk are available to the public.

### BACKGROUND

This application relates to Mortgage Backed Securities. Being long-term in nature, Mortgage Backed Securities (30 years and 15 years are the most common terms) is a good vehicle for corporate pension fund, annuity life insurance institution, etc to hedge against their long-term liability with the confident of not only generating reasonable income but also preserving principal of their investment. Banks with majority of their liabilities (deposits, CD, etc.) in shorter term; therefore, would prefer packaging their mortgage assets in the secondary market to reduce the risk of assets vs. liability duration mismatch.

However, many investors have refrained from MBS since there have been a high degree of skepticism regarding the market. Many institutional investors have limits to hold below-investment-grade debt. This can take the form of regulations, capital requirements, or investment restrictions imposed by committee. Bond insurers also have been on the hot seat during credit crisis as their ability to insure and back MBS. MBS (RMBS-residential, CMBS-commercial, etc) being the largest one (dollar amount wise) in size among all Asset Backed securities (ABS). bring transparency and confident back will definitely help promoting the marketability of MBS.

To access the risk of MBS investment, we could evaluate the risk characteristics of borrower, collateral, and loan itself. Due to the long term duration in nature, on going maintain of FICO score which provide lots of information regarding characteristics of borrower for the vast pool of MBS (which is in the trillion dollars market) is deem in-effective. If we perform an audit of the FICO score, there will definitely be some changes any time. What percentage of accuracy is then considered valid? Not to mention, borrower's consent is typically required to obtain such information; therefore, making this approach impractical.

The mortgage industry also relies on property value determinations, frequently involving a human appraiser who can sometimes be less objective. Conventional mortgage scoring only uses a point estimate of the value of the property, and no forecast of the future direction of the price of the property. Weighted Average Margin Test measure the difference between market value and face value of collateral. Again, market value could be subjective; therefore, making these type of data less auditable. “Law of One Price” suggests that securities should have the same market value as its underlying collateral. In practices, this is often not the case.

Because quality of securitized assets is ever changing due to time and structure-dependent volatility, this type of security has an inherent risk to the structure. Credit crunch has confirmed that ABS poses risk to financial market due to fundamental flaw that causes all tranches to be extremely high risk for investors. Severe downturn in the housing market was not modeling for collateral of RMBS market. Investors unable to gauge ABS structure and performance relied on ratings which also collapsed during crisis.

There is a need for an improved method that provides a practical and objective measurement of risk. (E.g. the risk of principal perseverance). The design of this product means to increase liquidity and marketability of MBS by giving investors confident regarding the risk in which investors' capital contribution is protected.

### SUMMARY

The pooling of mortgage backed securities (MBS) will have tranches per risk of principal perseverance with auditable historical and current data available to the public. Per historical statistic downside risk of collateral sales price fall short of original market price which could go to extreme during market stress time, tranches (Classes) are pooled as

1. Risk Free Tranch with 3 standard deviation of downside risk to protect against 99.97% of variances

2. Grade AA Tranch with 2 standard deviation of downside risk to cover 95% of price variances

3. Investment Grade Tranch with 1 standard deviation of downside risk to protect against 68% of collateral downside market price variances

4. Speculated Grade with high downside market price variances risk; however, is also reimbursed for risk taking with higher interest rate.

Pooling of tranch is not limited to these four categories provided and could be more granular or more general per needs. The exact composition of pool may vary depending on the goals of the vehicle. Pooling of tranch could be also enhanced with other critical data per type of assets (rent rate for commercial property, etc) the main idea here is to pool tranches per actual historical statistic data with perseverance of principal as main concern. Other risk statistic factors could also be integrated in the system.

Database available to public including

1. Foreclosed property's 30 years historical data

2. MBS 30 years' historical performance data

3. Current on the market active MBS database

These tables are not to cover all fields which could be added per institutions' special needs. Prepayment risk for MBS due to shifting of yield curve is not the main goal for this product; however, prepayment rate for calculating historical performance need to be disclosed to the public.

The above summary addresses only main risk of default and should not be construed as a comprehensive description of all aspects, especially not at the exclusion of the learning in the specification, claims and figures. The main idea is enable investors to view risk under the vast pool of MBS with readily available and auditable data.

### BRIEF DESCRIPTION OF THE FIGURES

Please note that data were created solely for demonstration purpose, and only partially printed.

FIG. 1 shows foreclosed property's historical performance data

FIG. 2 shows historical MBS performance data

FIG. 3 shows current on the market active MBS database

### DETAILED DESCRIPTION

Currently, mortgage backed securities are divided into tranch by some term or interest rate. A stripped mortgage-backed security divides the mortgage payment into principal and interest, and uses each individually to back separate securities, i.e. interest-only SMBS and principal-only SMBS. Generally, this design relates to the risk involved with prepayment of mortgages in the pool. Under current historical low point of interest rate with the possibility of interest rate being raised in the near future, prepayment risk for MBS due to shifting of yield curve is not the main concern for this product. This design is to pool tranch per risk of principal perseverance.

Due to long term in nature, disproportionate number of borrower with high credit ratings my leave the pool over time resulting in degradation of the security due to increased risks of defaults associated with the remaining borrowers. Presently, this adjustment over time to reflect the change in condition is not available to investors or to rating agencies. This design to pool tranch per down payment, as time passed, the weighted average loan balance to collateral for the pool will get smaller; therefore, with even lower risk.

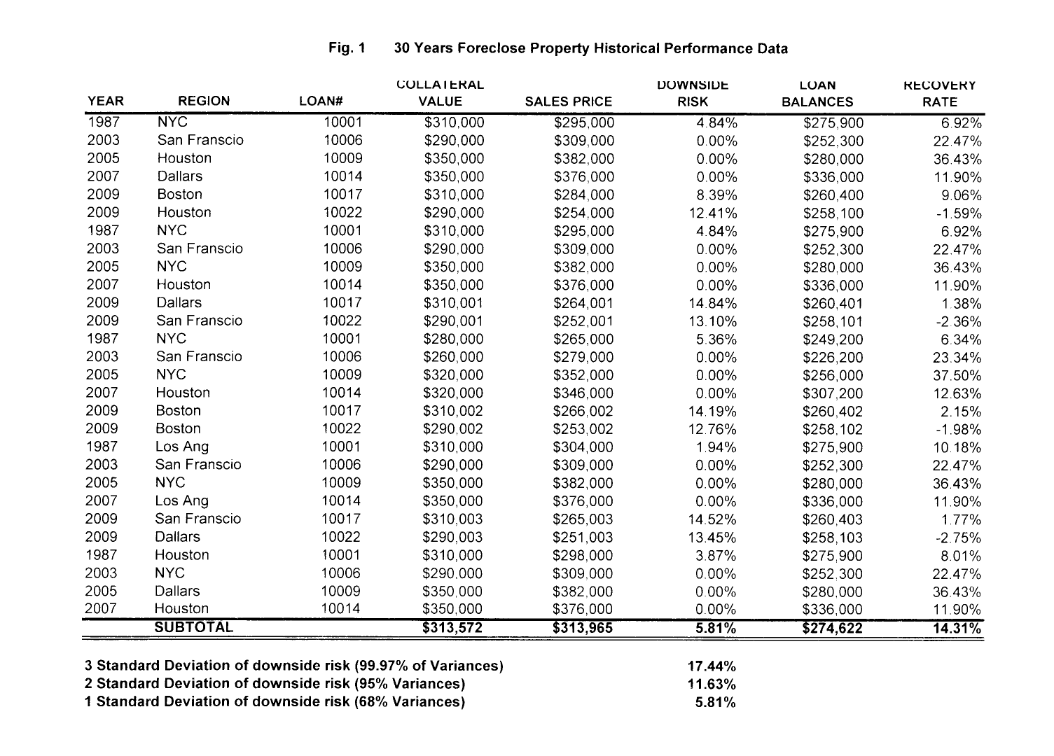

Changes in collateral, the underlying assets that make up the asset pool also have an extreme effect on structure products. As property prices fallen dramatically during credit stress time, there is a call for better transparency. FIG. 1 shows database to assess risk of foreclose loss. Per 30 years' historical data which cover several market stress term, tranches are pooled per statistic standard deviation of down side market pricing variances with perseverance of principal as main concern.

1. Risk Free Tranch (99.97% variances covered)—down payment more than 18% (17.44% run up)

2. Grade AA Tranch (95% covered)—down payment more than 12% (11.63% run up)

3. Investment Grade Tranch (68% covered)—down payment more than 6% (5.81% run up)

4. Speculated Tranch—down payment less than 6% (5.81% run up)

If downside 3 standard deviation of historical market price is 17.44%, pooling tranch with mortgage down payment more than 18% will cover more than 99.97% of downside market pricing variances; therefore, is considered risk free tranch. As time passed, the weighted average loan to collateral ratio for the pool will get smaller; therefore, the original risk assumed is lower as time passed. Tranches pooled between downside risk of 3 standard deviation and 1 standard deviation will be protected against 68% of downside market price variances. Per example data provided under FIG. 1, tranches pooled with down payment between 18% and 6 are then considered investment grade tranches. Speculated tranch with down payment less than 6% (5.81% run up) is then with the highest risk of downside pricing variances; however, is also reimbursed with higher interest rate. If there are a lot less liquidity for the speculated tranch, then underwriting organizations will gradually tighten their lending policy and require higher down payment since there are few willing to subside this type of speculated risk. If sophisticated investors finding opportunities to garb higher return during market up cycle, then there is marketability for speculated tranch. Lending policy will then be driven by market force. The main point is that risk need to be clearly disclosed per auditable database and available to the public. As time passed, the weighted average loan to collateral ratio for all tranches will get smaller; therefore, the original risk assumed is lower as time passed.

Pooling of tranch is not limited to these four categories provided and could be more granular or more general per needs. The exact composition of pool may vary depending on the goals of the vehicle. Pooling of tranch could be also enhanced with other critical data per type of assets (ex. rent rate for commercial property, etc) the main idea here is to pool tranches per actual historical statistic data with clear down side risk assessment and perseverance of principal as main concern. Other risk statistic factors could also be integrated in the system.

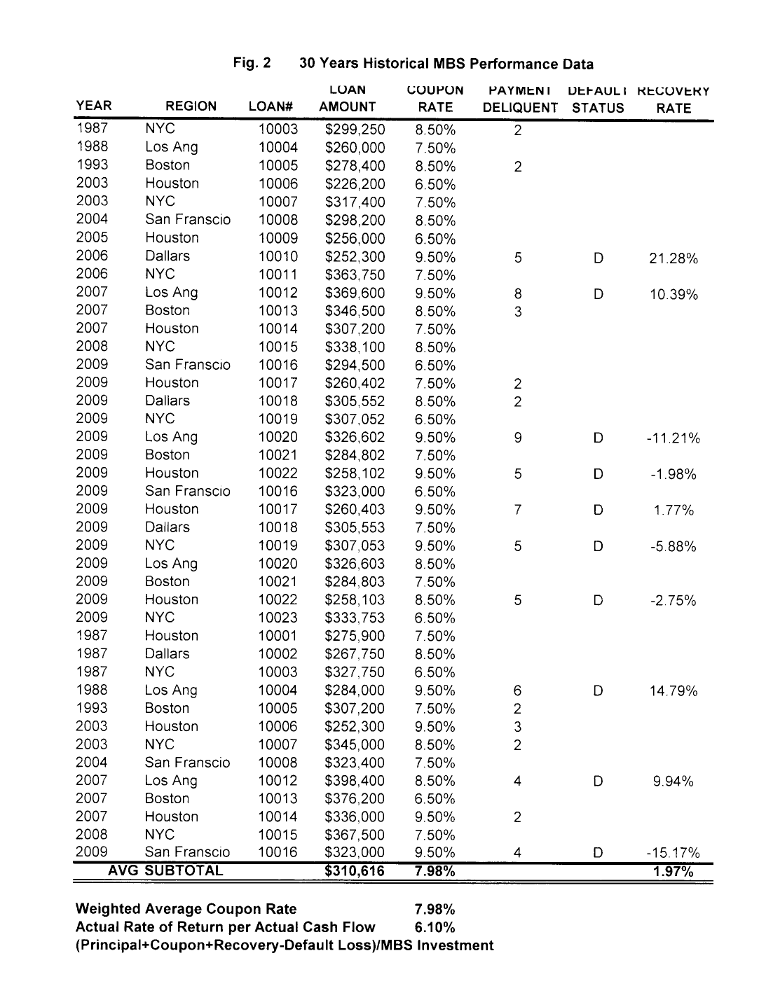

FIG. 2 displays 30 years historical mortgage backed security performance data of similar type of MBS. By comparing Weighted Average Coupon Rate vs. Actual Rate of Return per Actual Cash Flow, we will notice there is several base point difference between stated and actual rate. All fields are not covered, for example, prepayments need to be incorporated to calculate actual rate of return. The main idea is to have auditable data available to the public calculating actual return per historical data and listing actual cash flow including default loss and recovery payment. More disclose could be added per type of property or needs of institution. The main idea here is auditable data to gauge the difference between stated rate and actual rate.

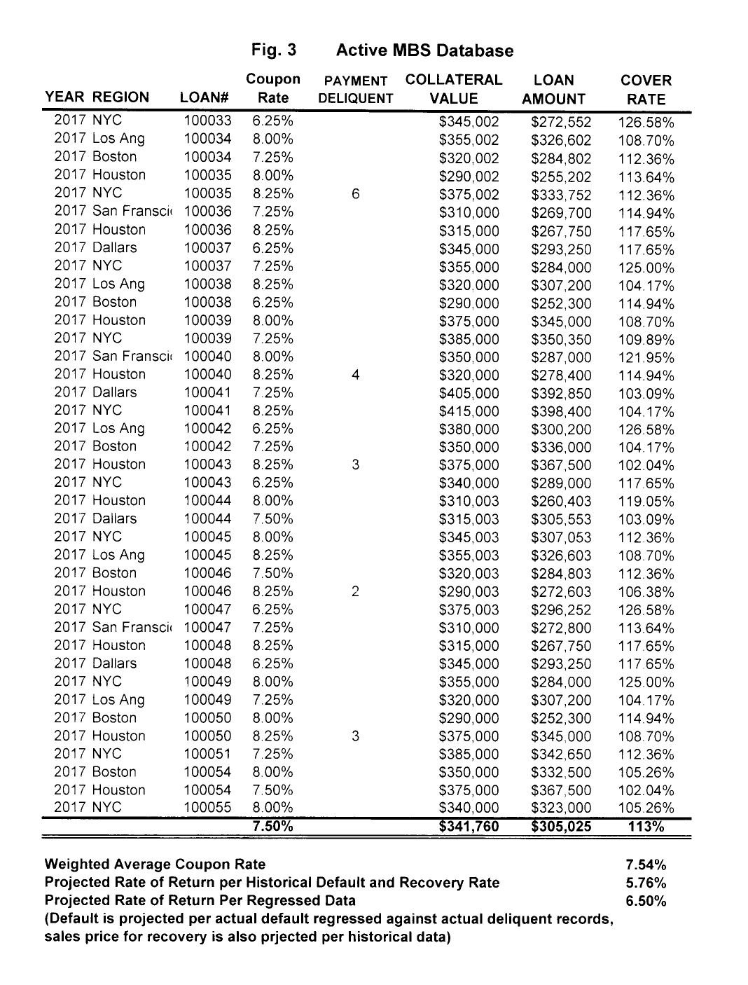

FIG. 3 lists similar data as FIG. 2, except FIG. 3 is an active MBS pool currently on the secondary market. To project potential default rate, current delinquent payment records are to be regressed against historical 30 years MBS delinquent data. To project recovery rate, potential delinquent loan collateral is regressed against historical foreclosed property. Projected rate of return are calculated per historical default and recovery rate which is 5.76% in this example. Projected Rate of Return per actual delinquent records is 6.5% since current market condition is better with less payment delinquent. Also, per 30 years' historical data which cover several market stress term, rate of return is deem lower and more conservative. Please also note that the weighted average cover rate of Collateral to Loan ratio at the bottom right of the corner is 113% for this actual MBS packaged to be sold. If investor is buying the Grade AA tranch, reviewing the actual database will validate that coverage rate 13% is more than 12% as proposed per statistic downside risk factor under FIG. 1.

### Operation

All tables designed are filterable per any fields in the heading; therefore, the downside risk of FIG. 1 could be populated per year, region, and any other preferred fields per institutions' special needs. For example, if the 113% weighted average cover rate of Collateral to Loan ratio of FIG. 3 represents unfiltered overall portfolio cover rate then buying tranch AA with higher price and lower return might be unnecessary since the overall cover rate is already above 12%. These tables are not to cover all fields which could be added per institutions' special needs. The main idea is enable investors to view risk under the vast pool of MBS with readily available and auditable data.

### Advantages

Currently MBS are stripped or pooled in tranch per prepayment risk. Advantages of pooling assets per principal at risk will broader range of investors with perseverance of capital as main concern. Auditable database available to investors decompose the risk and increase the transparency for the products. These data available to investors are objective and auditable; therefore, will enhance confident and liquidity for the secondary MBS market.

### Conclusion

The more secure tranches with default remote risk of non-agency MBS will deem to have the strongest liquidity. The speculated tranch will then provide higher rate of return to compensate the risk for more sophisticated investors.

Pooling of tranch is not limited to categories provided and could be more granular or more general per specific needs. The exact composition of pool may vary depending on the goals of the vehicle. Pooling of tranch could be also enhanced with other critical data per type of assets (rent rate for commercial property, etc). Other risk statistic factors could also be integrated in the system.

The main idea here is to pool tranches per actual historical statistic data with perseverance of principal as main concern.

Database provided are not to cover all fields which could be added per institutions' special needs.

The above summary addresses only main risk of default and should not be construed as a comprehensive description of all aspects, especially not at the exclusion of the learning in the specification, claims and figures. The main idea is enable investors to view risk under the vast pool of MBS with auditable data.

1. (canceled)

2. (canceled)

3. A Mortgage Backed Security (MBS) comprising plurality of trenches (tranch) pooling per percentage of downpayment with said percentage based on verifiable statistic standard deviation of historical market price fall short of original asset price.

4. Whereby investors can audit or verify at any point of the life of said MBS pooling with this devise not only the historical foreclosed property databases but also current on the market mortgage statistic figures thereby substantially reduced the difficulty in maintaining 100% accuracy of FICO Score mass database with long term in nature of this type of securities.
Said trenches comprising of the following:
a) A trench pooling with % of downpayment more than 3 standard deviation of historical foreclosed properties fall short of original asset prices to protect against 99.97% of downside pricing variances; therefore, is considered a risk free trench.
b) A trench pooling with % of downpayment between 1 & 2 standard deviation of asset price downside variances to protect against 68% of downside risk;therefore, is considered a investment grade trench.
c) A trench pooling with % of downpayment less than 1 standard deviation of asset price downside variations; therefore, is considered a speculative trench.
d) said trenches; however, are not limited to above categories and could be more granular or more general per institutions' need.
e) trench pooling; however, not excluding the integration of other minor factors like rent rate for commercial property, prepayment risk, etc per institutions' need.
